(19) United States
(12) Patent Application Publication
(10) Pub. No.: US 2016/0035036 A1
(43) Pub. Date: Feb. 4, 2016

(54) USER SPECIFIC PURCHASING GUIDE SYSTEMS AND METHODS

(71) Applicant: PAYPAL, INC., San Jose, CA (US)

(72) Inventor: David Edward Eramian, San Jose, CA (US)

(21) Appl. No.: 14/884,605

(22) Filed: Oct. 15, 2015

Related U.S. Application Data
(63) Continuation of application No. 13/930,444, filed on Jun. 28, 2013.

(51) Int. Cl. G06Q 40/06; G06Q 30/02; G06Q 30/06

(52) U.S. Cl. CPC G06Q 40/06; G06Q 30/0601; G06Q 30/0206

(57) ABSTRACT

There is provided systems and method for a user specific purchasing guide. The methods include receive user specific financial information corresponding to a user, receive item specific pricing information corresponding to an item selected by the user, and determine user specific purchase recommendations for the item using the user specific financial information, the item specific pricing information, and general price predictors, wherein the user specific recommendations include at least a time and price to purchase the item.

### CROSS REFERENCE TO RELATED APPLICATIONS

This application is a continuation of U.S. patent application Ser. No. 13/930,444, filed Jun. 28, 2013, which is also hereby incorporated by reference in its entirety.

### BACKGROUND

1. Technical Field

The present application generally relates to user specific purchasing guides and more specifically to a user specific application providing product purchasing guidance.

2. Related Art

As consumers increasingly look to a variety of websites for deals on products, manufacturers and service providers aim to provide statistical information to assist these consumers in their purchases. Statistical information may include best times to purchase, future sales or bargains, considerations of inventory and seasonal purchasing, or other data corresponding to price predictors of goods or services. Thus, consumers may be apprised of bargains and ideal times to purchase these goods or services based on historical price predictors. However, these price predictors are not user specific and thus provide an incomplete assessment of an ideal time to purchase the goods or services based on the user's current financial situation. Therefore, the user may make, or refrain from making, purchases at an ideal time for the user due to incomplete information.

### BRIEF DESCRIPTION OF THE DRAWINGS

FIG. 1 is a block diagram of a networked system suitable for implementing the process described herein according to an embodiment;

FIG. 2 is an exemplary application interface for presenting a user specific purchasing guide to a user according to an embodiment;

FIG. 3 is a flowchart showing an exemplary process by a service provider server for providing a user specific purchasing guide according to an embodiment; and

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

In certain embodiments, a service provider (e.g., a financial services provider, data provider, payment provider, etc.) may include a database having item pricing data, such as item specific pricing information and/or item specific price predictors. The item pricing data may include data enabling a server to make general recommendations corresponding to pricing for an item at different times. Additionally, the provider may enable a user to set up a user account with the provider and transmit user specific financial information to the provider. The user specific financial information may correspond to tax information such as the user's tax bracket and expected tax payments/refunds, current assets such as bank account balances and income streams, and other user financial information. Using the user specific financial information and the item specific pricing information, the provider may determine a best time for the user to purchase an item corresponding to the user's financial situation and the item's pricing information. Additionally, the provider may utilize general price predictors, such as seasonal pricing information, expected depreciation, and/or other general pricing data to provide an assessment of an ideal purchase time.

In one embodiment, a user sets up an account with a service provider and submits or provides the service provider access to view the user's income streams, present bank account balance(s), debt(s), budget, and/or any other desired or accessible financial information of the user, including credit card activity/statements, stock holdings, and bank activity/statements. The user also may specify an item or provide the service provider with user account settings designating types of items, preferences, or other information corresponding to items the user may find desirable. The service provider receives item specific pricing data, for example from a marketplace server. Additionally, the service provider server may include a set of general price predictors. Using the user specific financial information, item specific pricing information, and the general price predictors, the service provider may determine and/or recommend an ideal time for the user to purchase the item. For example, the user may be required to utilize credit, such as a credit card, to purchase the item at the lowest general price. However, the user may incur credit card fees and/or interest due to the purchase, which may be inferred by the user carrying over balances on user credit card accounts, making the item more expensive to the user at lowest potential purchase price. Thus, the service provider may instead determine that it is in the user's best financial interest to purchase the item after the user's next paycheck, or other time the user has sufficient financial funds on hand, thus the service provider may recommend another time to purchase. In certain aspects, the recommendation of another time to purchase may include a specific time to purchase (e.g., a specific day, week, or month), or a range during which the user should purchase (e.g., between 1-2 days, 2-5 days, 5-10 days, and the like). In various embodiments, the service provider may suggest alternative payment sources, such as short term credit, for the user to purchase an item at an ideal time for the user.

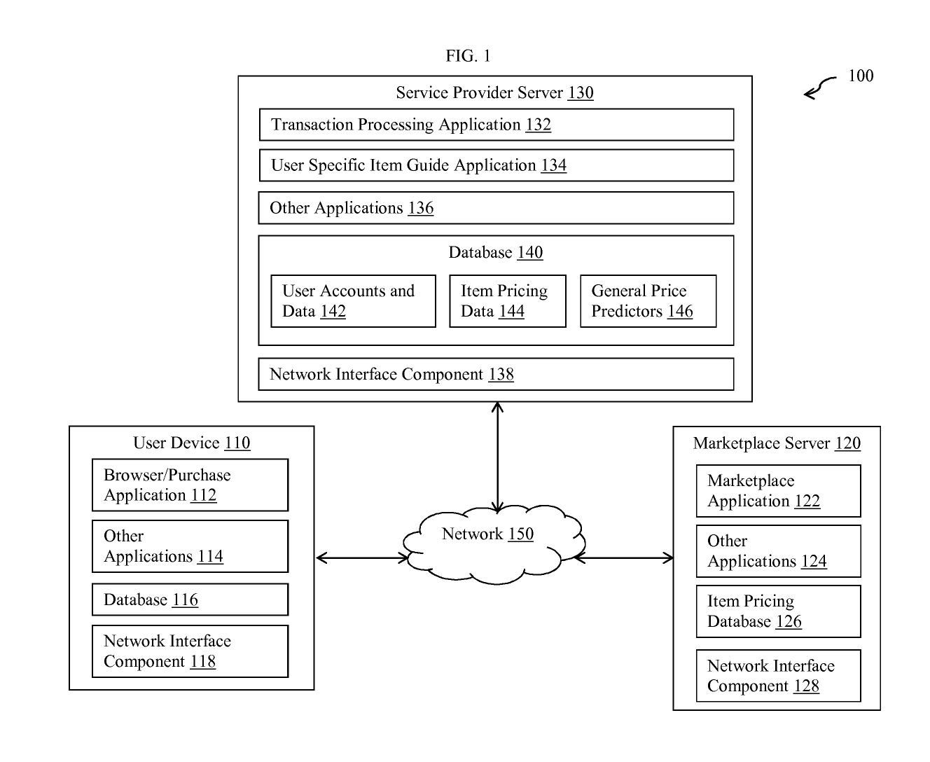

FIG. 1 is a block diagram of a networked system 100 suitable for implementing the process described herein according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user device 110, merchant server 120, and a service provider server 130 in communication over a network 150. A user, such as a consumer, utilizes user device 110 to make a purchase with one or more merchants and/or view purchase recommendation items. These actions may be facilitated by service provider server 130 in certain embodiments.

User device 110, merchant server 120, and service provider server 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system environment 100, and/or accessible over network 150.

User device 110 may be implemented using any appropriate hardware and software configured for wired and/or wireless communication over network 150. For example, in one embodiment, user device 110 may be implemented as a personal computer (PC), a smart phone, personal digital assistant (PDA), laptop computer, and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a browser/purchase application 112, other applications 114, a database 116, and a network interface component 118. Browser/purchase application 112 and other applications 114 may correspond to processes, procedures, and/or applications executable by a hardware processor, for example, a software program. In other embodiments, user device 110 may include additional or different software as required.

Browser/purchase application 112 may be used, for example, to provide a convenient interface to permit a user to browse information available over network 150. In one embodiment, browser/purchase application 112 may be implemented as a web browser configured to view information available over the Internet or access a website of a service provider. Browser/purchase application 112 may be utilized to access marketplace websites and engage in online transactions. Additionally, browser/purchase application 112 may access service provider websites, such as a payment provider, to facilitate online payments, financial websites to view financial information and engage in financial transactions, and/or other online actions. Browser/purchase application 112 may further be utilized to access an online marketplace and view items and general item recommendations. Browser/purchase application 112 may also access a service provider to submit item preferences and user financial information in order to view and/or receive buyer specific item purchase recommendations, such as a buyer specific purchasing guide.

In other embodiments, browser/purchase application 112 may correspond to a specific application utilized by user device 110 to effectuate purchases with an online marketplace. In such embodiments, browser/purchase application 112 may enable a user to view and purchase items, submit item preferences, and provide financial information as described herein. Additionally, browser/purchase application 112 may provide buyer specific item purchase recommendations, such as a buyer specific purchasing guide. Thus, browser/purchase application may correspond to an application available for download from service provider over network 150.

In various embodiments, user device 110 includes other applications 114 as may be desired in particular embodiments to provide desired features to user device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. Other applications 114 may contain software programs, such as a graphical user interface (GUI), executable by a processor that is configured to provide an interface to the user.

User device 110 may further include database 116 which may include, for example, identifiers such as operating system registry entries, cookies associated with browser/purchase application 112, identifiers associated with hardware of user device 110, or other appropriate identifiers, such as identifiers used for payment/user/device authentication or identification. In one embodiment, identifiers in database 116 may be used by a service provider, such as service provider server 130, to associate user device 110 with a particular account maintained by the service provider. Database 116 may further contain user specific financial information for transmission to a service provider server, or may include data to access user specific financial data.

For example, database 116 may contain further user specific financial information, such as user bank statements, financial accounts, assets, tax information, income streams, debts, outgoing payments, and/or other user financial information. In various embodiments, database 116 may include information to access user financial information including online account access information. Thus, user device 110 may transmit user specific financial information included in database 116 to a service provider in order to receive buyer specific item purchase recommendations, such as a buyer specific purchasing guide. However, in other embodiments, a user of user device 110 may enter the user specific financial information to a service provider and choose to store only some, or none, of the user specific financial information in database 116 of user device 110.

In various embodiments, user device 110 includes at least one network interface component (NIC) 118 adapted to communicate with network 150 including merchant server 120 and service provider server 130. In various embodiments, network interface component 118 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Merchant server 120 may be maintained, for example, by a merchant or seller offering various items, products, and/or services through an online site or application. Generally, merchant server 120 may be maintained by anyone or any entity that receives money, which includes charities as well as retailers and restaurants. In this regard, merchant server 120 may include processing applications, which may be configured to interact with user device 110 and/or service provider server 130 over network 150 to facilitate the sale of products, goods, and/or services. In one example, merchant server 120 may be provided by Ebay®, Inc. of San Jose, Calif., USA.

Merchant server 120 includes a marketplace application 122, other applications 124, an item pricing database 126, and a network interface component 128. Marketplace application 122 and other applications 124 may correspond to processes, procedures, and/or applications executable by a hardware processor, for example, a software program. In other embodiments, merchant server 120 may include additional or different software as required

Merchant server 120 may include marketplace application 122, which may be configured to serve information over network 150 to user device 110 and/or service provider server 130. In one embodiment, a user may interact with marketplace application 122 to view and purchase various items available. Thus, marketplace applications 122 may include a marketplace interface displayable on user device 110. Marketplace application 122 may facilitate the exchange of money for items using user device 110 and/or service provider server 130. Additionally, marketplace application 122 may determine item specific pricing data, including item sales histories, inventories, bargains, rebates, and/or other item pricing data.

In various embodiments, merchant server 120 includes other applications 124 as may be desired in particular embodiments to provide desired features for merchant server 120. For example, other applications 124 may include security applications for implementing server-side security features, programmatic server applications for interfacing with appropriate application programming interfaces (APIs) over network 150, or other types of applications. Other applications 124 may also include a payment/checkout application configured to accept payment of items selected by a user through marketplace application 122. Other applications 124 may contain software programs, such as a graphical user interface (GUI), executable by a processor that is configured to provide an interface to the user.

Merchant server 120 includes an item pricing database 126 identifying available products, goods, and/or services (e.g., collectively referred to as items) which may be made available for viewing and purchase by a user. Item pricing database 126 may include tracking numbers for the items, stock amounts, prices, rebates, coupons, and other item information. Item pricing database 126 may further include analytics corresponding to item prices, for example, historical pricing fluctuations, seasonal sales, seasonal demands for the item including pricing changes due to inventory levels, and/or other desired analytics. Item pricing database 126, in various embodiments, may be utilized to provide item pricing predictors to consumers, such as lowest item pricing times/dates, inventory levels, and/or other information affecting an item pricing. For example, item pricing database 126 may include data enabling merchant server 120 to suggest general times to purchase an item, such as an airline fare/travel package, consumer electronic, or other item to consumers.

In various embodiments, merchant server 120 includes at least one network interface component (NIC) 128 adapted to communicate with network 120 including user device 110 and service provider server 130. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Service provider server 130 may be maintained, for example, by an online payment service provider, which may provide processing for online financial transactions on behalf of a user with a merchant. In this regard, service provider server 130 includes one or more processing applications which may be configured to interact with user device 110 over network 150 to facilitate payments between user device 110 and merchant server 120. In one example, service provider server 130 may be provided by PayPal®, Inc. of San Jose, Calif., USA. However, in other embodiments, service provider server 130 may be maintained by a financial services provider, financial data provider, and/or other service provider, which may provide financial services, information, and/or analytics to a user's financial information. In this regard, service provider server 130 may not facilitate payments between user device 110 and/or merchant server 120 and instead provide a user specific purchasing guide to a user for use in financial planning.

Service provider server 130 of FIG. 1 includes a transaction processing application 132, user specific item guide application 134, other applications 136, database 140 having user accounts and data 142, item pricing data 144, and general price predictors 146, and a network interface component 138. Transaction processing application 132, user specific item guide application 134, and other applications 136 may correspond to processes, procedures, and/or applications executable by a hardware processor, for example, a software program. In other embodiments, service provider server 130 may include additional or different software as required.

Service provider server 130 may include a transaction processing application 132, which may be configured interact with browser/purchase application 112 of user device 110 over network 150 to facilitate payments to merchant server 120. In various embodiments, transaction processing application 132 includes features to receive a request to issue a payment and effectuate the payment to merchant server 120 for an item. However, in various embodiments, service provider server 130 may provide a user specific purchasing guide using user specific guide application 134 absent transaction processing application 132.

In various embodiments, service provider server 130 includes a user specific item guide application 134, which may include one or more applications to receive and process information from user device 110 and/or merchant server 120 as described herein. User specific item guide application 134 may include processes to establish, set-up, and manage a user account and receive user information. For example, user specific item guide application 134 may create a user account and receive user specific financial information from user device 110, such as bank account statements, income streams, debts owed, tax information, or other user financial information. User specific item guide application 134 may also be given access to online financial information corresponding to the user, such as online banking login information, stock and/or stock portfolio information, other investment information, other income stream information, online bill payment information, and/or other online financial information. User specific item guide application 134 may store this information in database 140 as user accounts and data 144.

Additionally, user specific item guide application 134 may receive item specific pricing information corresponding to one or a plurality of items. For example, user specific item guide application 134 may receive item specific pricing data from item pricing database 126 of merchant server 120. As previously discussed, item specific pricing data may correspond generally to item specific pricing information, such as item price predictors for item price and/or purchase recommendations to consumers generally. User specific item guide application 134 may store the data in database 140 as item pricing data 142. In various embodiments, user specific item guide application 134 may track one or a plurality of items corresponding to a user. However, in other embodiments, user specific item guide application 134 may track a items across a wide breadth of categories, across all user's designated interests, or by another desired subsection of items.

User specific item guide application 134 may further containing processes, applications, and/or software to process user specific financial information in user accounts and data 142 and item specific pricing information in item pricing data 144 with general price predictors 146 to make a user specific item purchasing guide including user specific purchase recommendations corresponding to an item. For example, the user specific purchase recommendations may include consideration of user assets, debts, and/or budgets when purchasing an item as well as the items pricing changes and any potential seasonal changes. The user specific purchase recommendations may consider the lowest price of the item, any potential lack of inventory based on seasonal changes (i.e. travel during the summer and product stocks during Christmas), as well as the user's financial situation. The user's financial situation may consider whether credit is required to purchase the item, whether the item will affect the user's investments, debt payments, and/or present budget considerations. Thus, the user specific purchase recommendation may make a recommendation of when the product is the most affordable to the user.

The user specific item guide application 134 may also transmit, render, and/or display an interface to a user. The interface may correspond to a user specific item purchasing guide including user specific purchase recommendations based on the collected and analyzed information from user accounts and data 142, item pricing data 144, and general price predictors 146, as described herein.

Service provider server 130 includes other applications 136 as may be desired in particular embodiments to provide desired features to service provider server 130. For example, other applications 136 may include security applications for implementing server-side security features, programmatic server applications for interfacing with appropriate application programming interfaces (APIs) over network 150, or other types of applications. Other applications 136 may contain software programs, such as a graphical user interface (GUI), executable by a processor that is configured to provide an interface to a user.

Additionally, service provider server 130 may include database 140 having user accounts and data 142, item pricing data 144, and general price predictors 146. As previously discussed user accounts and data 142 may include established user accounts and corresponding user specific financial information. Additionally, user accounts and data 142 may include user information, such as name, address, birthdate, payment/funding information, and/or other desired user data. As previously discussed item pricing data may include item specific pricing information. General price predictors 146 may correspond generally to established price predictors for items generally, and specific subsets of items. For example, general price predictors 146 may include price considerations for increased prices and decreased inventories during holidays. Additionally, general price predictors may consider travel and/or lodging to be at a premium during summer. Thus, general price predictors may consider additional factors affecting an item cost.

In various embodiments, service provider server 130 includes at least one network interface component (NIC) 138 adapted to communicate with network 150 including user device 110 and marketplace server 120. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

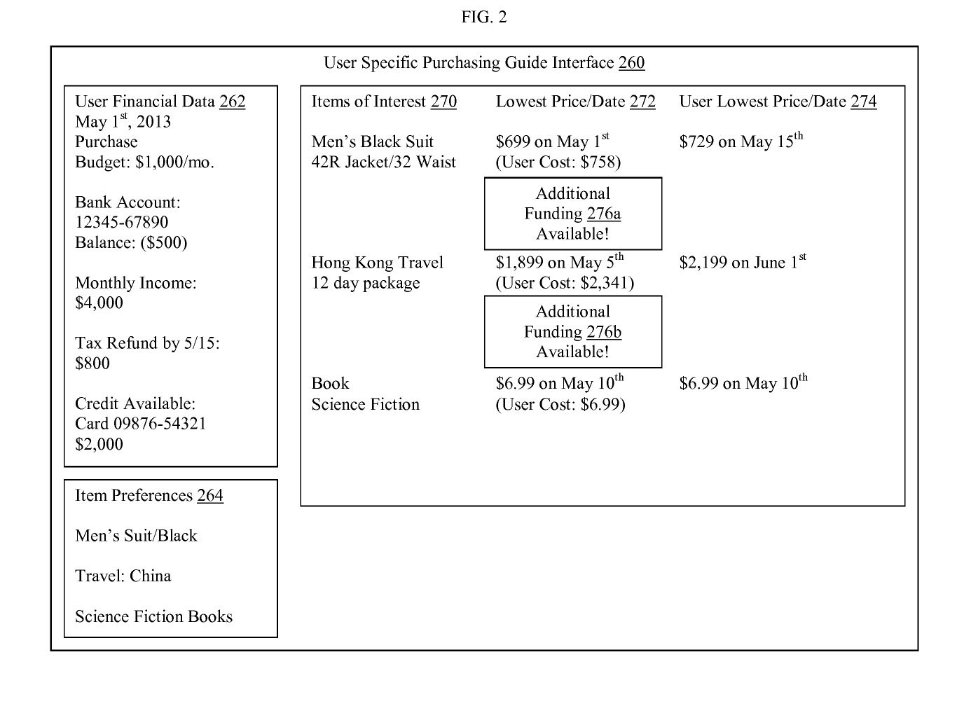

FIG. 2 is an exemplary application interface for presenting a user specific purchasing guide to a user according to an embodiment. FIG. 2 shows an application interface corresponding generally a software interface of a user specific item guide application, executable by a hardware processor, for providing a user specific purchasing guide having item recommendations, such as purchase prices and dates, to a user. Thus, user specific purchasing guide interface 260 may correspond generally to an application interface of user specific item guide application 134 of FIG. 1.

User specific purchasing guide interface 260 of FIG. 2 includes user financial data 262, item preferences 264, items of interest 270, lowest price/date 272, and user lowest price/date 274. As shown in FIG. 2, user financial data 262 includes user financial data, such as bank account information, income streams including monthly income and one time income amount, such as a tax refund, payments, such as mortgage payments, rent, utilities, phone, and any other periodic or semi-regular payments, and available credit. A user may further include a purchase budget, for example based on other debts, and/or may specify debts owed. As shown in FIG. 2, the user has a purchase budget of $1,000 per month and has $2,000 available of credit, for example using a credit card. Additionally, the user is expecting a $800 refund by May 5^{th}, and has $500 available in cash in a bank account.

Item preferences 264 may include account preference settings designating items desired by a user. In various embodiments, the user may specify items and/or item categories to watch. Thus, the user may be made aware of sales, rebates, coupons, or other savings for specified items. The categories may correspond to any goods, service, or product desired by a user. Although generic categories are shown in FIG. 2, more specific categories and/or items may be used, such as a brand and product type.

User specific purchasing guide interface 260 also contains items of interest 270 corresponding generally to item preferences 264. Items of interest 270 may be populated using item preferences 264. However, in other embodiments, items of interest 270 may be populated by a user, for example, when browsing a merchant server, such as a marketplace application, and designating certain items to follow. Items of interest 270 is shown with three products corresponding to preferences of item preferences 264. In FIG. 2, items of interest 270 contains 3 items of varying prices based on item specific pricing information, user specific financial information, and general price predictors, as discussed herein.

Lowest price/date 272 may include the lowest price available for an item. The lowest price available for an item may correspond to a lowest price prediction based on item specific pricing information. Thus, as shown in FIG. 2, the lowest price for the men's black suit is $699 on May 1^{st}. The lowest price may consider sales, rebates, coupons, or other item pricing predictors. However, the user of user specific purchasing guide interface 260 does not currently have enough money to purchase the men's black suit on May 1^{st}. Thus, using the credit available to the user, the total cost after potential credit fees and/or interest rates may actually cost a user $758.

Lowest price/date 272 also shows that while a travel package to Hong Kong is on sale for $1,899 on May 5^{th}, using credit available to the user, the total cost to the user will actually be $2,341 if purchased on that date. Additionally, the user may have sufficient purchasing power to make certain purchases when an item is at a lowest foreseeable price. Thus, the science fiction book is on sale for $6.99 on May 10^{th}, and the user may purchase the book at that date at a lowest price.

However, the user is expecting a tax return of $800 on May 15^{th}. Additionally, the user has $500 in their bank account and can expect to add $1,000 more to their purchase budget in the next month. Thus, the user will expect to have $2,300 of available money to purchase items within the next month.

Thus, user lowest price/date 274 considers the available income streams, item pricing, and general price predictors, to present a user specific purchase recommendation including at least a price and a date for the item. The user specific purchase recommendation considers the user will have sufficient money on May 15^{th} to purchase the men's black suit. Additionally, the user will have sufficient money on June 1^{st} to purchase the Hong Kong travel package. This considers item price fluctuations with user specific financial information to determine these are the best times to purchase the designated item. For example, based on tax return received by May 15^{th}, the user may purchase the men's black suit for $729, which is less than the user would spend if purchased at the item's lowest price on May 1^{st}. Moreover, the user may wait until June 1^{st}, when the user has saved a tax refund and another $1,000 spending budget, to purchase the Hong Kong travel package for $2,199.

The user may additionally receive additional funding 276a and 276b options corresponding to funding options for an item, such as the men's black suit and/or the Hong Kong travel. Additional funding 276a and 276b may correspond to funding offered by a service provider or other funding source, such as a short term loan, new credit cards, bill me later options, or other funding options.

In addition to income data, purchase recommendations may also be based on reductions or expected reductions of available income, such as mortgage payments, rent, utility payments, loan payments, costs associated with an upcoming vacation, unusually large (or small) credit card payments, etc. Thus, if the user is expecting a large outflow of available cash or income during a certain period, purchase recommendations may be based on this and adjusted accordingly.

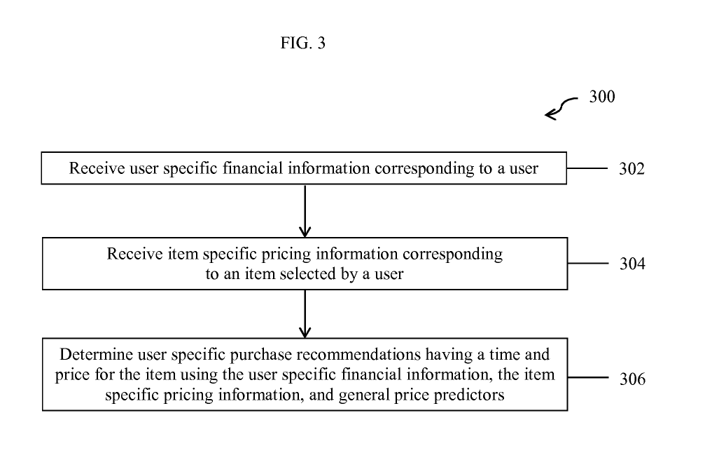

FIG. 3 is a flowchart showing an exemplary process by a service provider server for providing a user specific purchasing guide according to an embodiment. Note that one or more steps, processes, and methods described herein may be omitted, performed in a different sequence, or combined as desired or appropriate.

At step 302, a server, such as service provider server 130, receives user specific financial information corresponding to a user. The user specific financial information may be entered in a user account corresponding to the user when establishing, setting up and/or maintaining the user account. The user specific financial information may also be transmitted to service provider server 130 from financial institutions and/or requested by service provider server 130. The user may enter account login information to one or more financial accounts with service provider server 130 or may have the financial institution transmit financial information to service provider server 130.

The user specific financial information may correspond to assets, present and potential, of the user. The assets may include present account holdings, income streams, expected income (e.g. tax refunds), interest payments, expected potential investment assets (e.g. stock price increases, dividends, etc.), and other held and potential assets. The user specific financial information may also include debts, present and potential, held by the user. Thus, the user specific financial information may include consideration of assets with debts held by the user, such as mortgage/rent payments, car payments, personal and property taxes, expected potential decrease of investment assets, and other held and potential debts. The user specific financial information may be stored with a user account in user accounts and data 142 of service provider server 130.

The server may receive item specific pricing information corresponding to an item selected by a user at step 304. The user may establish a user account service provider server 130 and make item selections and/or item preference selections in the user account. Service provider server 130 may then receive item specific pricing data, such as item price predictors from merchant server 120. Item specific pricing information may establish predicted prices at various points in time based on sales data, new items, seasonal considerations of a specific item, inventories, or other item specific price predictors. The item specific pricing information may be stored in item pricing data 144 of service provider server 130.

At step 306, server determines user specific purchase recommendations including a purchase time and price for the item using the user specific financial information, the item specific pricing information, and general price predictors. As discussed herein, general price predictors may give consideration to price fluctuations due to holidays, seasons, or other typical buying patterns of consumers. Thus, using information in database 140 of service provider server 130, a recommendation of a time and price of a product may be made to the user of when the product is at an ideal time to purchase for the user. As shown in lowest price/date 272 of FIG. 2, the user may be able to purchase one of items of interest 270 at a lowest possible price on certain dates. However, with accrued fees, the lowest possible price may end up costing the user more than if the product is purchased at a different date. Thus, user lowest price/date 274 displays a time and price recommendation to the user of when to purchase on of items of interest 270.

Additionally, the user may be offered options to finance the purchase with service provider server 130, for example, by clicking additional funding 276a/276b. As service provider server 130 is aware of the user's current income streams, service provider server 130 may be able to offer financing for the item at a lower rate than the user would find elsewhere.

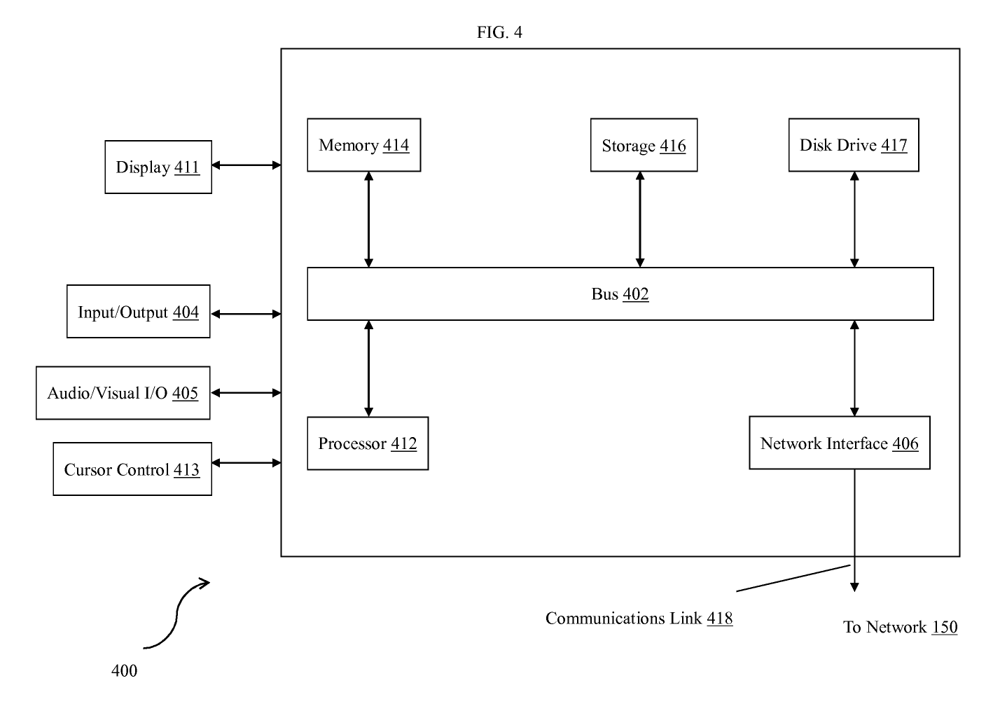

FIG. 4 is, a block diagram of a computer system 400 suitable for implementing one or more embodiments of the present disclosure. In various embodiments, the user device may comprise a personal computing device (e.g., smart phone, a computing tablet, a personal computer, laptop, PDA, Bluetooth device, key FOB, badge, etc.) capable of communicating with the network. The merchant server and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a service provider server via network 150. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider's system, comprising:
a non-transitory memory storing a website application interface for a purchasing guide website provided by the service provider and an account for a user;
one or more hardware processors coupled to the non-transitory memory and configured to read instructions from the non-transitory memory to cause the system to perform operations comprising:
receiving a login request to the account with the purchasing guide website from an application executing on a device used by the user;
determining an item of interest to the user for purchase based on user preferences stored with the account;
determining user financial data for the user, wherein the user financial data comprises income and debts of the user;
determining whether the user will receive at least one of a new income or a new debt different from the income and the debts using the user financial data;
accessing pricing information for the item of interest;
determining recommendation data using the pricing information and comprising a time for purchase by the user of the item of interest using the user financial data and the determination of whether the user will receive the at least one of the new income and the new debts at the future time; and
outputting the recommendation data through a graphical user interface of the application executing on a device for the user, wherein the recommendation data is displayed with the account of the user on the purchasing guide website.

2. The system of claim 1, wherein the pricing information comprises seasonal price changes, and wherein the recommendation data comprises a graphical indicator of a seasonal alert displayed through the graphical user interface.

3. The system of claim 1, wherein the pricing information comprises price fluctuation predictors of the item of interest caused by at least one of seasonal pricing predictors for the item of interest at a future time, inventory predictors for the item of interest, and consumer buying pattern predictors for the item of interest by other consumers.

4. The system of claim 3, wherein the time for purchase comprises a present data when the price fluctuation predictors indicate an increasing price, and wherein the time for purchase comprises a future date when the price fluctuation predictors indicate a lowest future price.

5. The system of claim 3, wherein the one or more hardware processors are further configured to read instructions from the non-transitory memory to cause the system to perform operations comprising:
determining available credit to the user for purchase of the item of interest using the user financial data, wherein the available credit comprises terms of credit having at least one of an interest rate and fees associated with use of the available credit;
determining a total cost for purchase of the item of interest at a present date using the available credit based on the terms of credit;
determining a future cost for the purchase of the item with available assets to the user at a future date using the price fluctuation predictors,
wherein the recommendation data comprises the total cost and the future cost.

6. The system of claim 5, wherein the time for purchase comprises the present date when the total cost is less than the future cost, and wherein the time for purchase comprises the future date when the future cost is less than the total cost.

7. The system of claim 1, wherein the pricing information comprises a current price of the item of interest, and wherein the pricing information further comprises an expected devaluation of the item of interest over time.

8. The system of claim 1, wherein the user financial data further comprises current assets held by the user.

9. The system of claim 8, wherein the debts of the user comprise mandatory debts required for payment by the user, and wherein the time to purchase does not cause the current assets of the user to fall below a threshold amount required for payment of the mandatory debts.

10. The system of claim 1, wherein the new income comprises one of a tax refund, a gift, and an investment payout.

11. The system of claim 1, wherein the new debt comprises one of personal taxes, a payout, and an investment loss.

12. The system of claim 1, wherein the one or more hardware processors are further configured to read instructions from the non-transitory memory to cause the system to perform operations comprising:
accessing personal information for the user from the account of the user, wherein the user financial data is determined using the personal information.

13. A method comprising:
receiving a login request to the account with the purchasing guide website from an application executing on a device used by the user;
determining an item of interest to the user for purchase based on user preferences stored with the account;
determining user financial data for the user, wherein the user financial data comprises income and debts of the user;
determining whether the user will receive at least one of a new income or a new debt different from the income and the debts using the user financial data;
accessing pricing information for the item of interest;
determining recommendation data using the pricing information and comprising a time for purchase by the user of the item of interest using the user financial data and the determination of whether the user will receive the at least one of the new income and the new debts at the future time; and
outputting the recommendation data through a graphical user interface of the application executing on a device for the user, wherein the recommendation data is displayed with the account of the user on the purchasing guide website.

14. The method of claim 13, wherein the pricing information comprises seasonal price changes, and wherein the recommendation data comprises a graphical indicator of a seasonal alert displayed through the graphical user interface.

15. The method of claim 13, wherein the pricing information comprises price fluctuation predictors of the item of interest caused by at least one of seasonal pricing predictors for the item of interest at a future time, inventory predictors for the item of interest, and consumer buying pattern predictors for the item of interest by other consumers.

16. The method of claim 15, wherein the time for purchase comprises a present data when the price fluctuation predictors indicate an increasing price, and wherein the time for purchase comprises a future date when the price fluctuation predictors indicate a lowest future price.

17. The method of claim 13, wherein the pricing information comprises a current price of the item of interest, and wherein the pricing information further comprises an expected devaluation of the item of interest over time.

18. The method of claim 13, wherein the user financial data further comprises current assets held by the user.

19. The method of claim 13, wherein the new income comprises one of a tax refund, a gift, and an investment payout.

20. A non-transitory machine-readable medium having stored thereon machine-readable instructions executable to cause a machine to perform operations comprising:
receiving a login request to the account with the purchasing guide website from an application executing on a device used by the user;
determining an item of interest to the user for purchase based on user preferences stored with the account;
determining user financial data for the user, wherein the user financial data comprises income and debts of the user;
determining whether the user will receive at least one of a new income or a new debt different from the income and the debts using the user financial data;
accessing pricing information for the item of interest;
determining recommendation data using the pricing information and comprising a time for purchase by the user of the item of interest using the user financial data and the determination of whether the user will receive the at least one of the new income and the new debts at the future time; and
outputting the recommendation data through a graphical user interface of the application executing on a device for the user, wherein the recommendation data is displayed with the account of the user on the purchasing guide website.
